(19) United States
(12) Patent Application Publication
(10) Pub. No.: US 2005/0004868 A1
(43) Pub. Date: Jan. 6, 2005

(54) Method for making payment possible in communications networks

(76) Inventors: Uwe Klatt, Berlin (DE); Thomas Ryll, Berlin (DE)

Correspondence Address: Kevin R. Spivak;Morrison & Foerster LLP, Suite 300, 1650 Tysons Boulevard, McLean, VA, 22102, US

(21) Appl. No.: 10/345,416

(22) Filed: Jan. 16, 2003

(30) Foreign Application Priority Data
Jan. 17, 2002 (EP) 02090022.1

(51) Int. Cl. G06F 17/60

(52) U.S. Cl. 705/40; 705/1

(57) ABSTRACT

The invention relates to a method for making a payment possible and a method for communicating between payment systems in communications networks. In order to permit a payment to a payee, a payment demand message which relates to a paying party is transmitted to a second payment system. The second payment system detects that the paying party is assigned to a first payment system, a payment message which relates to the payment demand message is sent to the first payment system from the second payment system by means of a signaling protocol which controls the setting up of communications links, in order to inform the first payment system about the payment demand message and thus make the payment possible.

### CLAIM FOR PRIORITY

This application claims priority to Application No. 02090022.1 which was filed in the German language on Jan. 1, 2002.

### TECHNICAL FIELD OF THE INVENTION

The invention relates to a method for making payment possible and to a method for communicating between payment systems in communications networks.

### BACKGROUND OF THE INVENTION

In “e-commerce,” it is necessary to carry out payment transactions using communications networks. Such payment transactions may occur, for example, when services or performances for which there is a charge (supply of information, data or goods) are provided over the communications networks. For example the Internet, telephone fixed networks or second and third generation mobile radio networks are used as such communications networks. In order to pay for the services or performances, methods are required, for example, for making cashless payments using a mobile terminal (for example a mobile phone, a laptop, personal digital assistants (PDA or Palmtops) and/or an Internet terminal (for example Internet computer). However, methods for making payments over communications networks are also required outside the scope of “e-commerce” and independently of the provision of services, for example when making donations.

In some cases, payees do not carry out relatively complex payment transactions themselves, but rather make use of payment service providers which operate payment systems for processing payment transactions. In some cases, a paying party (for example a customer, consumer), a payee (for example a trader, service provider, merchant) and a payment system of a payment service provider are therefore involved in such payment transactions. Both the paying party and the payee, in this case, make use of the services of the payment service provider and/or of the payment system.

### SUMMARY OF THE INVENTION

The present invention discloses a method with which payments can be made possible between a paying party and a payee in a simple and reliable way, even if the payment service provider which is used by the paying party is unknown to the payee, or vice versa.

In one embodiment according to the invention, there is a method for making a payment using a first communications network, a communications terminal of a paying party being assigned to a first payment system of the first communications network and a payee being assigned to a second payment system, in which method a payment demand message which relates to the paying party is transmitted to the second payment system by the payee, the second payment system detects that the paying party is assigned to the first payment system, a payment message which relates to the payment demand message is sent to the first payment system from the second payment system by means of a signaling protocol which controls the setting up of communications links, in order to inform the first payment system about the payment demand message and thus make the payment possible.

In one aspect, a payment is made possible between the paying party and the payee even if a different payment system is assigned to the paying party from that assigned to the payee. It is also advantageous that for the transmission of the payment messages a signaling protocol is used which controls the setting up of communications links and is provided for an entirely different purpose (namely for signaling and thus preparing the setting up, the maintenance and the release of voice telephone calls, for example). As a result, the method according to the invention can be implemented in a simple, uncomplicated and cost-effective way.

In another embodiment according to the invention, the first payment system is connected to the first communications network, and the second payment system is connected to a second communications network, and the first communications network can be connected to the second communications network by means of the signaling system which controls the setting up of communications links. It is advantageous here that the method according to the invention can be applied even if the payment systems which are involved are located in different communications networks and are connected to them.

In still another embodiment according to the invention, the first payment system brings about a debiting of a payment sum from a payment account, when the debiting is successful a success message is transmitted to the second payment system from the first payment system by means of the signaling system which controls the setting up of communications links, and in response a receiver success message is transmitted to the payee from the second payment system. It is particularly advantageous here that as a result of the use of the (for example prepaid) payment account of the paying party for the payee there is no risk of a failure to pay. In this embodiment of the invention, it is possible to use the prepaid credit accounts which are known for paying tolls in telecommunications networks.

In yet another embodiment according to the invention, the first payment system brings about registration of the payment sum for later settlement with the paying party, when registration is successful a success message is transmitted to the second payment system from the first payment system by means of the signaling system which controls the setting up of communications links, and in response a receiver success message is transmitted to the payee from the second payment system. Such a method makes it advantageously possible to settle the payment sums with the paying party in a delayed fashion by means of invoices; for example the network operator invoicing systems which are known in telecommunications networks can be used for this.

In one aspect of the invention, it is possible to use the Session Initiation Protocol (SIP) as the signaling system which controls the setting up of communications links. This Session Initiation Protocol is often used to signal the setting up, execution and release of, for example, voice telephone calls in telecommunications networks. Payment messages can be transmitted with a low degree of effort by using the protocol which is per se already known but provided for entirely different purposes.

A message “INVITE” which is set up according to the specifications of the Session Initiation Protocol is sent as payment message. A header of the message “INVITE” may include information (and therefore be transmitted with the message) which makes it possible for the first payment system to process the payment.

A message “200 OK” which is set up according to the specifications of the Session Initiation Protocol can be sent as success message. A header of the message “200 OK” may include information (and consequently be transmitted with the message) which makes it possible for the second payment system to assign the message “200 OK” to the previously transmitted message “INVITE”.

The exemplary embodiments mentioned above have the advantage that messages which are already known can be used and only have to be adapted for use with the method according to the invention. As a result, devices (for example switching offices) which are used for transporting Session Initiation Protocol messages do not need to be modified, or only need to be modified slightly, as they are designed to transport these messages.

In another embodiment of the invention, there is a method for communicating between a first payment system of a first communications network and a second payment system, it being possible for the first payment system to carry out first payment transactions between first paying parties which are assigned to the first payment system and first payees which are assigned to the first payment system, for the second payment system to carry out second payment transactions between second paying parties which are assigned to the second payment system and second payees which are assigned to the second payment system, in which method, in order to permit an outside payment transaction between one of the first paying parties and one of the second payees, a payment message which relates to the outside payment transaction is sent to the first payment system from the second payment system by means of a signaling system which controls the setting up of communications links. It is advantageous here, that, for the transmission of the payment messages, a signaling protocol which controls the setting up of communications links and which is provided per se for an entirely different purpose (namely for signaling and thus preparing the setting up, the maintenance and the release of voice telephone calls, for example) is used. As a result, the method according to the invention can be implemented in a simple and uncomplicated way and thus also particularly cost-effectively.

In one aspect of the invention, the method may be configured such that the payment systems are connected to different communications networks and a plurality of communications networks can be connected by means of the signaling protocol which controls the setting up of communications links. A communication between the payment systems can thus advantageously take place even if said payment systems are assigned to different communications networks.

Here, the Session Initiation Protocol can be used as signaling protocol which controls the setting up of communications links. By using this protocol which is already known per se but is provided for entirely different purposes it is possible to transmit the payment messages with a low degree of effort.

In the previously known method, a SIP User Agent can be formed by the first payment system, and a SIP Server can be formed by the second payment system.

### BRIEF DESCRIPTION OF THE DRAWINGS

In order to explain the invention further,

FIG. 1 shows a schematic view of two communications networks for carrying out the methods according to the invention.

FIG. 2 shows an exemplary embodiment of a sequence of the methods according to the invention.

### DETAILED DESCRIPTION OF THE INVENTION

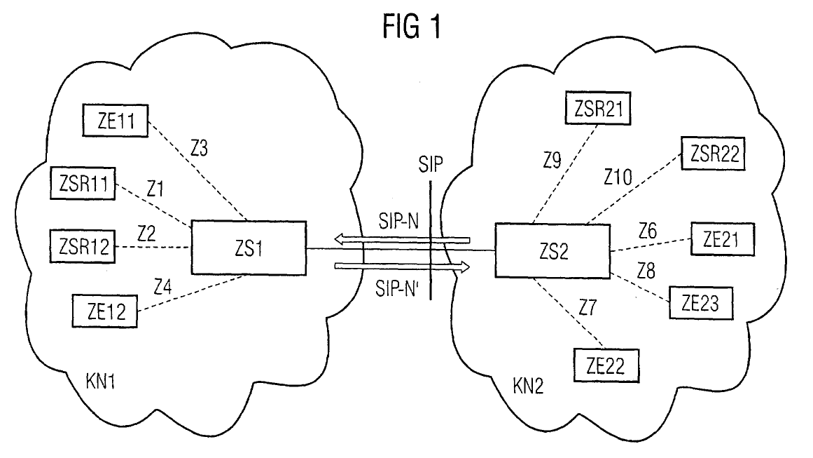

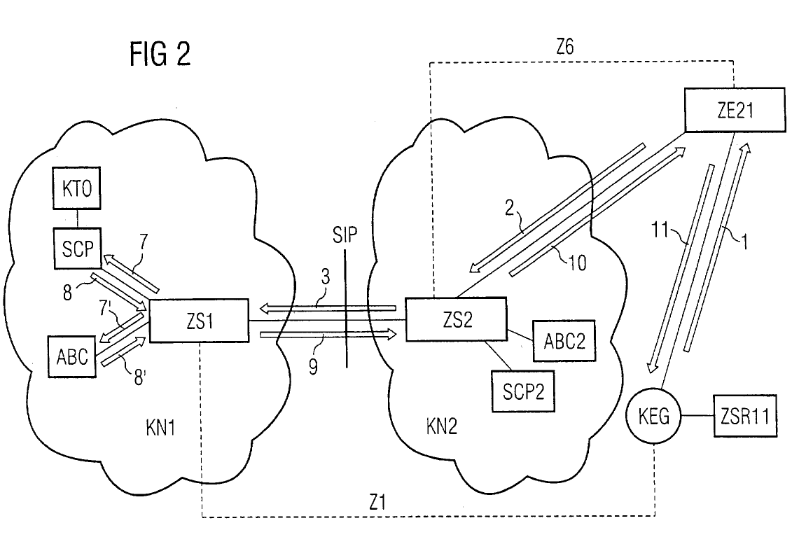

A first communications network KN1 is illustrated on the left-hand side of FIG. 1, which communications network KN1 may be, for example, a telephone communications network (that is to say for example a fixed network or a mobile radio network) or else part of the Internet. In this exemplary embodiment, the first communications network is in the form of a telephone network which has the structure of an intelligent network (IN=Intelligent Network), (cf. FIG. 2). In the first communications network KN1 there is a first payment system ZS1 which is assigned a multiplicity of paying parties and payees. By way of example, a first paying party ZSR11, a second paying party ZSR12, first payee ZE11 and a second payee ZE12 are illustrated, these being assigned to the first payment system ZS1 (they have for example signed on to the first payment system ZS1 and are registered as permitted users in a database (not illustrated) of the first payment system ZS1). The assignments are symbolized as dashed lines Z1, Z2, Z3 and Z4. The payment system ZS1 per se is capable of permitting payment transactions between the paying parties and payees assigned to it and carrying them out. For example, a specific amount of money can be debited from a credit account (not illustrated) of the second paying party ZSR12 and credited to an account (also not illustrated) of the first payee ZE11.

A second communications network KN2 is illustrated on the right-hand side of FIG. 1, which communications network KN2 may also be a telephone communications network or part of the Internet. In this exemplary embodiment, the second communications network is also in the form of a telephone network which has the structure of an intelligent network (IN), (cf. FIG. 2). In the second communications network KN2 there is a second payment system ZS2 which is also assigned a multiplicity of paying parties and payees. By way of example, a third paying party ZSR21, a fourth paying party ZSR22, a third payee ZE21, a fourth payee ZE22 and a fifth payee ZE23 are illustrated, these being assigned to the second payment system ZS2; the assignments are symbolized as dashed lines Z6 to Z10. The payment system ZS2 per se is capable of measuring possible payment transactions between the paying parties ZSR21 and ZSR22 assigned to it and the payees ZE21, ZE22 and ZE23, and/or carrying them out.

In order to make possible and carry out payment transactions even between paying parties and payees which are assigned to different payment systems (such payment transactions are to be referred to as outside payment transactions), messages SIP-N and SIP-N′ describing such outside payments are transmitted between the payment systems by means of a signaling protocol SIP which controls the setting up of communications links. Here, the messages SIP-N and SIP-N′ are set up according to a Session Initiation Protocol (SIP). Session Initiation Protocol is described in the publication “SIP-Session Initiation Protocol” by M. Handley et al., Request for Comments: 2543, Network Working Group, of March 1999. The payment systems are configured for this purpose in such a way that they are capable of transmitting SIP messages structured according to the Session Initiation Protocol (SIP) to other payment systems and receiving them from other payment systems.

The payment systems can be located, as illustrated in FIG. 1, in the respective communications networks and they can form, for example a network node of the communications networks. However, the payment systems can also exist independently of the communications networks and be merely connected to them.

FIG. 2 illustrates the first communications network KN1 which is already known from FIG. 1, the first payment system ZS1 of a first payment service provider as well as the second communications network KN2 and the second payment system ZS2 of a second payment service provider. A method for making payment possible and a method for communicating between payment systems will be described in detail below.

By way of example it will be described that a purchaser would like to make a purchasing transaction with a trader and a payment to the trader by the purchaser for this payment transaction is made possible and is carried out. The purchaser therefore constitutes in this case the paying party ZSR11 (referred to in FIG. 1 as “first paying party”) who has a communications terminal KEG (for example a mobile phone, a laptop or a palmtop). This paying party ZSR11 normally carries out his payments using the first payment system ZS1 of a payment service provider). For this reason, the communications terminal KEG is assigned to the first payment system ZS1 of the first communications network KN1. The assignment is represented symbolically by the dashed line Z1. (To be precise, the telecommunications terminal is often not assigned to the first payment system but rather the assignment is implemented using information which is stored on a chip card—what is referred to as a SIM card of a user of the communications terminal—which is connected temporarily to the communications terminal at the time of use. However, at the time of use the communications terminal and the chip card constitute one unit so that in this sense the communications terminal is actually assigned to the payment system). The trader constitutes the payee ZE21 (referred to in connection with FIG. 1 as “third payee”) who processes his payments using the second payment system ZS2. For this reason, the second payment system ZS2 (assignment Z6) is assigned to the payee ZE21 (or to his payee communications terminal which is not represented in more detail). The first communications network KN1 may be, for example, a communications network in which the payment service provider of the purchaser is also simultaneously the network operator. Likewise, the second communications network KN2 may be a communications network in which the payment service provider of the trader is the network operator; but this is not necessary.

The paying party ZSR11 then transmits a purchasing message (arrow 1) to the payee, ZE21 by means of his communications terminal KEG in order to activate the purchasing transaction. The payee determines the price of the desired purchased object and sends a payment demand message (arrow 2) to the second payment system ZS2. The payee ZE21 has a contractual relationship with this second payment service provider owing to the fact that the payee ZE21 frequently carries out payment transactions with the second payment system ZS2 of the second payment service provider so that, by means of the second payment system ZS2, the second payment service provider becomes active immediately in response to the payment demand message 2 for the payee ZE21. A network operator of the second communications network KN2 often assumes the role of a payment service provider so that it is sufficient if the payee sends the payment demand message 2 to the network operator of the second communications network KN2, it being possible for the second communications network KN2 to be, for example, the communications network over which the payee normally makes his communications links.

The payment demand message 2 which is transmitted to the second payment system ZS2 includes, inter alia, data on the paying part ZSR11, for example its mobile telephone number MSISDN. The second payment system ZS2 detects, (for example by means of the mobile telephone number MSISDN after searching through a database) that the paying party ZSR11 (or its communications terminal KEG) is not assigned to the second payment system ZS2, that is to say has, up to now, not signed on at the second payment system in order to use it for payments.

However, the second payment system ZS2 detects from the information about the paying party (for example from the mobile phone number MSISDN of its communications terminal KEG), the information being supplied along with the payment demand message 2, that the paying party is a subscriber of the first communications network KN1 and that consequently this subscriber processes his payment transactions by means of the first payment system ZS1 of the first communications network KN1. However, it is also possible for the second payment system ZS2 to receive this information in some other way; for example a database, in which information about possible paying parties as well as the payment systems used by them and therefore assigned to their communications terminals is contained, can be connected to the second payment system ZS2.

In response, the second payment system ZS2 generates a payment message 3 which relates to the payment demand message 2, the payment message 3 being in the form of a message “INVITE” which is structured according to the Session Initiation Protocol (SIP). This message “INVITE” is changed in comparison with its previously known structure in that any information which is required by an outside payment system to make the payment transaction possible and carry it out, that is to say to process the payment, is inserted into the header of said message.

The second payment system ZS2 then sends the payment message 3 which is modified in this way to the first payment system ZS1. Here, the second payment system ZS2 acts as what is referred to as a SIP User Agent. The first payment system ZS1 receives the payment message 3; the first payment system ZS1 acts here as what is referred to as a SIP Server.

In this exemplary embodiment, the first payment system ZS1 receives, with the payment message 3, the request to debit a specific amount of money from the paying party ZSR11. The first payment system ZS1 then determines (for example by interrogation from a database assigned to it) that the paying party ZSR11 preferably makes payments using a payment account KTO assigned to it in the form of a credit account (for example a prepaid account of the communications network KN1). In response, the first payment system ZS1 transmits a payment request (arrow 7) to an intelligent node SCP (Service Control Point) of the first communications network KN1 which has a structure of an intelligent network IN (Intelligent Network). The service control point SCT has access to the payment account KTO of the paying party ZSR11 and brings about debiting of the respective sum of money from the account KTO. When the debiting is successful, the service control point SCP confirms this to the first payment system ZS1 by means of a corresponding information message (arrow 8). In response, the first payment system sends a success message 9 to the second payment system ZS2 by means of the signaling protocol SIP which controls the setting up of communications links. The message “200 OK” which is structured according to the specifications of the Session Initiation Protocol is used as success message. This message is modified in terms of its known structure in that its header is provided with an additional item of identification information (with an identification number, for example) which makes it possible to assign this message “200 OK” to the message “INVITE” which was dispatched earlier to the second payment system ZS2.

On receipt of this success message 9, the second payment system ZS2 is therefore informed about the successful debiting transaction. In a following step, the second payment system ZS2 transmits a receiver success message 10 to the payee ZE21 (in this case to the trader) by means of the successful debiting transaction, said payee sending an item of information 11 to the communications terminal KEG of the paying party ZSR11 in response, and with which information 11 the trader informs the paying party ZSR11 about the successful payment and transmits, for example, information about the supply of the purchased product or about the purchased or ordered performance of a service. If the paying party has purchased information data (for example information about stock prices) from the payee, this information data can also be transmitted directly with the information message 11 to the communications terminal KEG of the paying party ZSR11 as the subject-matter of the purchase.

If—in contrast to the previously described method—the information that the paying party ZSR11 normally makes payments by invoice (and not as described above by means of the payment account KTO) is present in the first payment system ZS1 of the first communications network KN1, the first payment system ZS1 can convey a message 7′ which is similar to the message 7 to an invoicing payment center ABC, instead of to the service control point SCP. As a result, the invoicing payment center ABC (ABC=Administration and Billing Center) brings about the registration of the payment sum for later settlement with the paying party. At a later time, the invoicing payment center ABC produces an invoice and transmits it to the paying party ZSR11. Immediately (in real time) after the registration of the payment sum, the invoicing payment center ABC sends a message H′, structured analogously to the message H, to the first payment system ZS1, in response to which the method is continued in a known fashion. With such a configuration of the method it is possible to use the invoice creation method which is customary in many communications networks also for carrying out the payment with the method according to the invention.

In order to carry out the payment, banks or credit card organizations can also be used by corresponding messages being conveyed by the first payment system ZS1 to technical facilities of the banks or credit card organizations. The first payment system ZS1 can also carry out currency conversions if the paying party uses a currency other than that of the payee.

Finally, it is to be noted that the second payment system ZS2 is also connected to a further service control point SCP2 and a further invoicing payment center ABC2. In this way, during a subsequent method sequence the roles of the first payment system ZS1 and of the second payment system ZS2 can be interchanged so that, for example, a further purchaser can also be assigned to the second payment system ZS2.

The described methods have a series of advantages: they permit payments above and beyond the limits of communications networks. In particular, such payments are made possible and carried out even if different payment systems are installed in different communications networks and the parties which are involved in the payment each use these different payment systems.

Using the Session Initiation Protocol specifications for the communication between the payment systems avoids a purely proprietary communication; instead smooth communication is made possible between different payment systems in different communications networks. Using the Session Initiation Communications Protocol which is known per se makes possible a method which can be implemented with little effort and is therefore cost-effective. The modification of known messages of the SIP protocol permits simple and straightforward communication between the payment systems involved. By means of these expansions, a communications mechanism which is already known per se is used according to the invention for payment purposes (charging purposes). As the SIP protocol is already applied in communications networks (for example in voiceover IP networks) for signaling purposes, a wide acceptance of the method according to the invention appears possible, even above and beyond the limits of networks.

1. A method for making a payment using a first communications network, a communications terminal of a paying party being assigned to a first payment system of the first communications network, and a payee being assigned to a second payment system, comprising:
transmitting a payment demand message which relates to the paying party to the second payment system by the payee;
detecting, using the second payment system, that the paying party is assigned to the first payment system; and
sending a payment message which relates to the payment demand message to the first payment system from the second payment system by a signaling protocol which controls the setting up of communications links, to inform the first payment system about the payment demand message and thus enabling the payment.

2. The method as claimed in claim 1, wherein the first payment system is connected to the first communications network, and the second payment system is connected to a second communications network, and the first communications network is connected to the second communications network by the signaling protocol which controls the setting up of communications links.

3. The method as claimed in claim 1, wherein the first payment system debits a payment sum from a payment account, and when the debiting is successful, a success message is transmitted to the second payment system from the first payment system by the signaling protocol which controls the setting up of communications links, and in response, a receiver success message is transmitted to the payee from the second payment system.

4. The method as claimed in claim 1, wherein the first payment system registers the payment sum for later settlement with the paying party, and when registration is successful, a success message is transmitted to the second payment system from the first payment system by the signaling protocol which controls the setting up of communications links, and in response, a receiver success message is transmitted to the payee from the second payment system.

5. The method as claimed in claim 2, wherein the Session Initiation Protocol is used as the signaling protocol which controls the setting up of communications links.

6. The method as claimed in claim 5, wherein a message “INVITE” which is set up according to the specifications of the Session Initiation Protocol is sent as payment message.

7. The method as claimed in claim 6, wherein information which permits the first payment system to process the payment is included in a header of the message “INVITE.”

8. The method as claimed in claim 5, wherein a message “200 OK” which is set up according to the specifications of the Session Initiation Protocol is sent as success message.

9. The method as claimed in claim 8, wherein information which enables the second payment system to make an assignment to the message “INVITE” is included in a header of the message “200 OK.”

10. A method for communicating between a first payment system of a first communications network and a second payment system, comprising:
performing, via the first payment system, first payment transactions between first paying parties which are assigned to the first payment system and first payees which are assigned to the first payment system;
performing, via the second payment system, second payment transactions between second paying parties which are assigned to the second payment system and second payees which are assigned to the second payment system; and
sending a payment message which relates to the outside payment transaction to the first payment system from the second payment system by a signaling protocol which controls the setting up of communications links in order to permit an outside payment transaction between one of the first paying parties and one of the second payees.

11. The method as claimed in claim 10, wherein the payment systems are connected to different communications networks and the communications networks are connected by the signaling protocol which controls the setting up of communications links.

12. The method as claimed in claim 10, wherein the Session Initiation Protocol is used as signaling protocol which controls the setting up of communications links.

13. The method as claimed in claim 10, wherein a SIP User Agent is formed by the first payment system, and a SIP Server is formed by the second payment system.

14. The method as claimed in claim 3, wherein the Session Initiation Protocol is used as the signaling protocol which controls the setting up of communications links.

15. The method as claimed in claim 4, wherein the Session Initiation Protocol is used as the signaling protocol which controls the setting up of communications links.
